(19) United States
(12) Patent Application Publication
(10) Pub. No.: US 2012/0175471 A1
(43) Pub. Date: Jul. 12, 2012

(54) REMOVABLE DEVICE FOR RUNNING A CABLE IN A CYCLE FRAME

(75) Inventor: Matthieu Lanz, Nevers (FR)

(73) Assignee: Look Cycle International, Nevers Cedex (FR)

(21) Appl. No.: 13/346,145

(22) Filed: Jan. 9, 2012

(30) Foreign Application Priority Data
Jan. 11, 2011 (FR) 1150226

(51) Int. Cl. F16L 3/08

(52) U.S. Cl. 248/73

(57) ABSTRACT

This removable device for running a cable in a cycle frame comprises a body (6) mounted resting on the frame, in an opening made for running the cable and comprising an orifice (19) for running the cable.

It also comprises a clamping member (7) mounted by screwing onto the body, the said clamping member being able to be deformed during screwing between a first, undeformed, rest configuration corresponding to a position in which the clamping member is inserted into the opening of the frame and a second, deformed configuration corresponding to a position in which the device is clamped against the frame.

### RELATED APPLICATION

This application claims priority to French application Ser. No. FR 11 50226, filed Jan. 11, 2011, the entire disclosure of which is incorporated herein by this reference.

The invention relates in general to cycle frames and relates in particular to the running of a cable through a cycle frame.

More particularly, the invention relates to a cable sheath stop making it possible to apply a tension force to the cable in order to actuate a mechanical member of the cycle, and to a sheath bushing designed to allow a cable surrounded by a sheath to run in a cycle frame.

As is known, the cables that are fitted to cycles connect the levers to the mechanical brake calliper or the derailleur.

Conventionally, the cables were first attached to the outside of the frame. It was then proposed to make them run partly inside the frame, in particular with respect to cycles for sporting or competition use. In any case, when the cables travel outside the frame, they are mounted so as to slide inside a sheath that is resistant to axial compression so as to allow a bearing hold in order to apply a tension force to the cable and actuate the corresponding mechanical member.

With respect to the routing of the cable inside the frame, several solutions have been proposed.

The first solution consists in providing an inner sheath into which the cable is inserted. This sheath is inserted into the frame during its manufacture. This solution is advantageous to the extent that it allows the cable to be guided in the frame during its installation or its replacement. Moreover, the cable entrance and exit orifices made in the frame can then be small which prevents compromising the rigidity and the reliability of the frame.

Another solution consists in running the cable in the frame with its own sheath. A sheath bushing is then advantageously used for the running of the cable and of its sheath in the frame.

Finally, a third solution consists in running the bare cable in the frame with no sheath. This solution is advantageous in terms of a saving in weight and efficiency. Specifically, the cable, bare in the frame, is subjected to much less friction and can therefore slide better.

In all cases, it has been found that running the cables in the frame allows an appreciable gain in terms of aerodynamics.

However, when a specific internal sheath is provided for the cable or when the bare cable is run in the frame, a cable stop must be provided at each cable-run opening against which the outer sheath of the cable rests.

The solution consisting in running the bare cable in the frame makes it possible to use an entrance orifice of relatively small dimensions. It is moreover possible to use a fixed sheath stop at the cable entrance. It is however necessary to have a large opening in the frame at its exit. A removable exit stop can then be installed to close the opening.

Various solutions have been proposed in the prior art for the production of a removable sheath stop.

First of all it has been proposed to position a cable-sheath stop in the frame opening and to hold it by virtue of the pressure applied by the sheath on the stop. It has however been found that such an arrangement does not make it possible to ensure the positioning of the stop in the frame opening, so that the stop tends to separate from its location and cause a direct contact of the cable on the frame which damages the frame.

It has also been proposed to produce the stop in the form of an elastically deformable element while giving the sheath stop a lug that is notched and can be deformed laterally so as to allow installation by snap-fitting the stop in the opening.

Finally it has been proposed to attach the sheath stop by screwing onto the frame. Although this solution is advantageous to the extent that it ensures the positioning of the stop in the opening, it involves providing a pierced hole in the frame immediately next to the opening of the frame, which tends to weaken it.

In this respect it is possible to refer to documents WO 2009097731; DE 20319887; EP-B-0184429; DE 202004017896; NL 1025343; U.S. Pat. No. 4,768,798; U.S. Pat. No. 4,915,404; U.S. Pat. No. 5,433,465; U.S. Pat. No. 5,478;100; U.S. Pat. No. 2010175517 and U.S. Pat. No. 7,114,738 which describe various cable-run arrangements in a frame. Document U.S. Pat. No. 5,478,100 provides in particular the mounting of a sheath stop by bonding or riveting to the frame.

In the light of the foregoing, the object of the invention is to propose, in general, a device for running a cable in a cycle frame making it possible to alleviate all or some of the aforementioned drawbacks.

Another object of the invention is to propose a cable-sheath stop dedicated to running a bare cable in a cycle frame and ensuring a reliable installation of the stop on the frame, while retaining the removable nature of the stop.

A further object of the invention is to propose a sheath-bushing device that can be reliably mounted on an opening made in a frame while remaining removable.

What is proposed therefore is a removable device for running a cable in a cycle frame, comprising a body mounted resting on the frame in an opening made for running the cable and comprising an orifice for running the cable.

This device also comprises, according to a general feature, a clamping member mounted by screwing onto the body, the said clamping member being able to be deformed during screwing between a first, undeformed, rest configuration corresponding to a position in which the clamping member is inserted into the opening of the frame and a second, deformed configuration corresponding to a position in which the device is clamped against the frame.

The body may comprise at least one additional orifice for the running of at least one other cable.

Advantageously, the clamping member has a shape to match that of the body and is prevented from rotating relative to the body in the undeformed position.

The clamping member may have a U-shaped cross section and comprise a base provided with a thread designed to receive a clamping screw and two lateral branches each provided with an end rim designed to press against the frame.

In one embodiment, the clamping member is made from a metal sheet folded in the form of a section piece.

It may for example be made of elastically deformable steel.

According to another feature, the body comprises a proximal head delimiting a peripheral shoulder designed to rest against an outer surface of the frame and a distal portion designed to be engaged in the opening of the frame.

In one embodiment, the distal portion of the body comprises two divergent longitudinal ramps on which the lateral branches respectively of the clamping member are pressed.

The orifice of the body is inclined relative to the general plane of the proximal head

The body may also comprise an axial hole for the passage of a clamping screw.

The body may also be made of any rigid material, such as aluminium, a plastic material, a composite, or a plastic material with added fibres.

In one embodiment, the cable-run device forms a cable-sheath stop, the body comprising a bearing surface for the sheath, the said bearing surface for the sheath comprising an annular surface surrounding the said orifice

In another embodiment, the cable-run device may form a sheath bushing.

Other objects, features and advantages of the invention will appear on reading the following description given only as a non-limiting example and made with reference to the appended drawings in which:

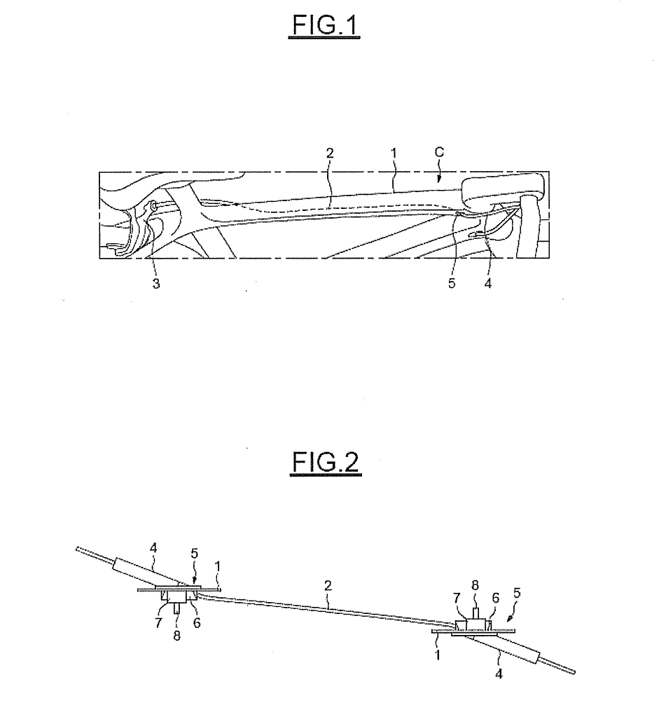

FIG. 1 is a partial view of a cycle frame showing the internal routing of a cable;

FIG. 2 illustrates the mounting of the cable on the frame;

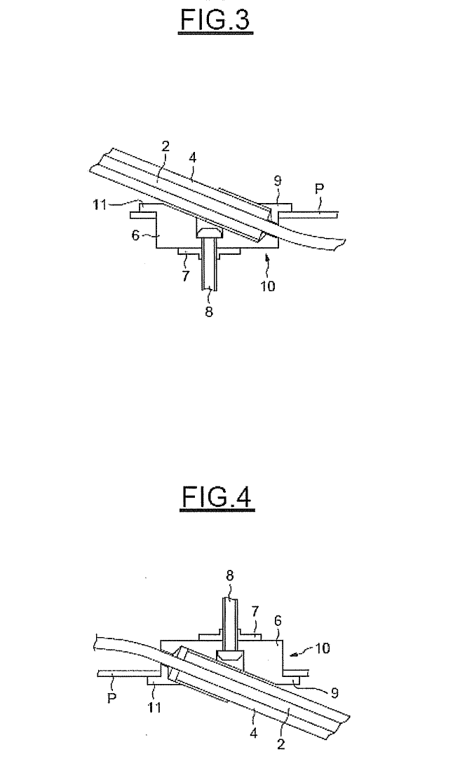

FIGS. 3 and 4 are detail views of FIG. 2 showing the positioning in the frame of a running device according to the invention forming sheath stops in the frame;

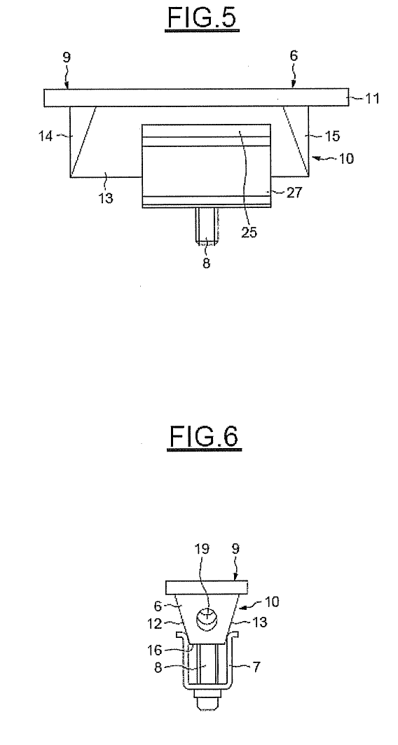

FIG. 5 is a side view of a sheath stop according to the invention;

FIG. 6 is a front view of the stop of FIG. 5;

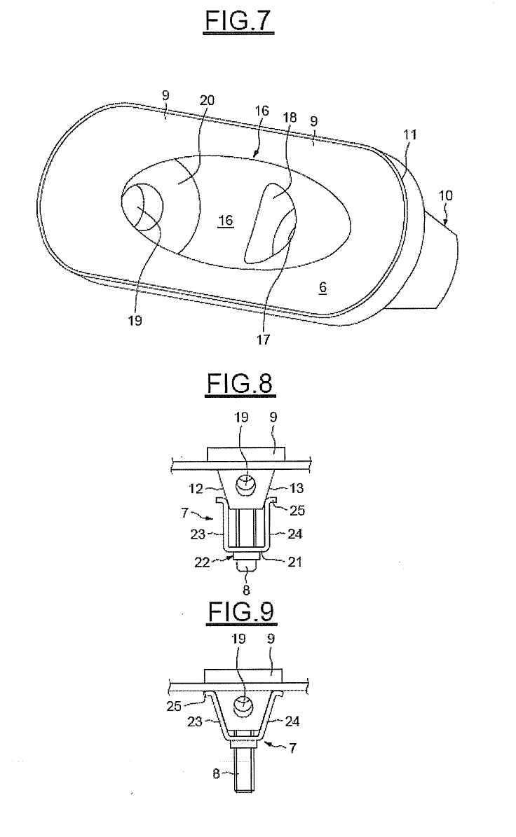

FIG. 7 is a view in perspective of the stop body;

FIGS. 8 and 9 show the sheath stop respectively in the rest position and in the clamped position; and

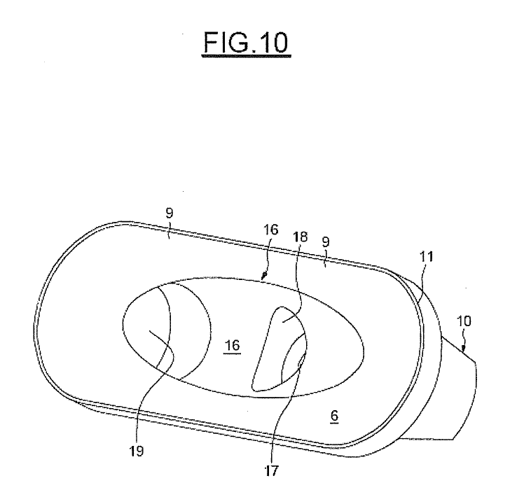

FIG. 10 illustrates another embodiment of a device according to the invention forming a sheath bushing.

With reference first of all to FIGS. 1 to 9, a description will first of all be given of a first embodiment of a cable-run device according to the invention in which the device forms a sheath step.

FIG. 1 shows a partial view of a cycle frame C and, in particular, its horizontal tube 1 in which a brake cable 2 travels stretched between a lever (not shown) provided for example on the bend of the handle bar, and a brake calliper 3.

In the envisaged application, the cable 2 runs bare in the tube 1 of the frame. When it extends outside the frame, it is surrounded by a conventional sheath 4 resistant to axial compression in order to allow a bearing hold in order to stretch the cable and actuate the calliper 3.

As is also seen in FIG. 2, the sheath stops 5 are mounted in openings made for this purpose in the frame in order to allow the running of the cable while delimiting stop surfaces for the sheath 4.

It will be noted that the application illustrated in FIGS. 1 and 2 shows specifically the running of a brake cable in the frame for the actuation of a brake calliper. But, as revealed in FIG. 1, which also shows the presence of a derailleur cable, the invention relates in general to the running of mechanical cables for the actuation of any mechanical member of the cycle capable of being actuated by cable or the running of an electric cable, notably for electric derailleur, or else the running of a hydraulic sheath notably for a braking system.

With reference to FIGS. 3 and 4, which illustrate a view in longitudinal section of the two sheath stops provided at the two cable-run orifices and also in FIGS. 5 and 6 which illustrate respectively a side view and a front view of a sheath stop, it can be seen that the stop 5 essentially comprises a body 6 being installed through the cable-run orifice made in the frame and pressing against the outer peripheral surface of the frame, a clamping member 7 and screw 8 providing, when tightening, the clamping of the member 7 against the inner surface of the wall P of the frame.

The stop body 6 comprises a proximal head 9 and a distal portion 10 which, on installation, is inserted in the cable-run orifice. The assembly is made in a single piece of hard and light material, for example of aluminium, of plastic, of composite, of plastic with added fibres, etc. or of any other hard and light material that is appropriate for the envisaged use. It will be noted that the stop body 6 is made so as to have cross sections of a shape that matches that of the cable-run orifice, the head 9 having increased dimensions so as to delimit a peripheral shoulder 11 by which the body 6 presses against the outer surface of the frame.

With reference more particularly to FIGS. 5 and 6, the distal portion 10 comprises two longitudinal edges 12 and 13 opposite one another and two transverse edges 14 and 15. As can be seen, the two longitudinal edges 12 and 13 form two rectilinear flat surfaces extending in a divergent manner from the free end 16 of the distal portion 10 towards the proximal head 9. The two transverse edges 14 and 15 have, for their part, a shape to match that of the cable-run orifice.

As shown in FIG. 7, the proximal head 9 in this instance has a generally oval shape and comprises, in its middle zone, a concave recess 16 provided, in its centre, with an axial hole 17 for the passage of the clamping screw 8 associated with a recess 18 designed to accommodate the head of the clamping screw. The recess 16 is also furnished with an orifice 19 dedicated to the running of the cable and offset laterally relative to the axial hole 17. This orifice is made in the stop body so that it is generally oriented in a plane of symmetry of the stop body while being inclined relative to the general plane of the head 9. As shown in FIGS. 3 and 4, it will be possible to make the orifice 19 in the stop body so that its axis forms an angle of approximately 30° relative to the general plane of the proximal head 9, depending on the desired angle of insertion of the cable into the frame.

When it involves running a mechanical cable, the head 9 is also furnished with a stop surface for the sheath. This surface is, in this instance, formed by an annular surface 20 surrounding the orifice so as to accommodate the free end face of the sheath. This annular surface 20 is then oriented perpendicularly to the axis of the orifice and thus forms, for example, an angle of approximately 60° relative to the general plane of the proximal head 9.

It will be noted however that the proximal head 9 may be furnished with one or more orifices for the running of one or more associated cables each, if necessary, with a stop surface.

With respect to the clamping member 7, the latter is for example made from a metal sheet that can be elastically deformed in the shape of a U section piece. This member 7 has a shape to match that of the body 6 and thus comprises a base 21 provided with a threaded orifice 22 or is associated with a fitted nut, designed to extend coaxially with the hole 17 and dedicated to the passage of the clamping screw, and two lateral branches 23 and 24 that can be deformed laterally and each provided with an end rim like 25 designed to press, on the clamping, against the inner surface of the frame tube.

At rest, the two lateral branches 23 and 24 extend in a generally parallel manner and are separated by a distance corresponding substantially to that of the two longitudinal edges 12 and 13 of the distal portion of the stop body, at their free end, while being slightly greater so as to allow the clamping member to be held on the stop body in a pre-assembled position.

The clamping member 7 is therefore capable of adopting a first configuration, that can be seen in FIG. 8, which corresponds to a preassembled position that is prevented from rotating, in which the two lateral branches 23 and 24 are not stressed or are slightly deformed so as to stay pressed against the end zone of the two longitudinal edges of the distal portion 10 of the stop body and a deformed position, that can be seen in FIG. 9, in which the two lateral branches 23 and 24 are deformed and parted from one another.

It will be noted that, in the rest position, the end rims 25 of the branches 23 and 24 are separated by a distance of less than a transverse direction of the cable-run orifice. On the other hand, on clamping, by means of the screw, the lateral branches 23 and 24 are deformed under the action of the longitudinal ramps 12 and 13 of the stop body so as to move apart by a distance greater than the lateral dimension of the cable-run orifice. In this position, the wall of the frame tube is clamped between the proximal head 9 of the stop body and the end edges of the clamping member so that the sheath stop is firmly held in position in the cable-run orifice.

The assembly however remains removable. Specifically, by loosening the clamping screw, the clamping member 7, guided by the longitudinal ramps 12 and 13 is replaced in its rest position allowing the sheath stop to be removed. It will be noted that the clamping and unclamping of the clamping member are made easier by making the end edges of these lateral branches with a curved shape making it easier for them to slide against the ramps 12 and 13.

As can be understood, the invention that has just been described, which uses a clamping member that can be deformed laterally by tightening onto a stop body, makes it possible to produce a removable sheath stop in a reliable arrangement, preventing any risk of inadvertent separation of the stop without requiring additional piercing of the frame which would be likely to compromise its rigidity and its reliability. It is therefore possible to propose a cable run in the frame which is advantageous in terms of aerodynamics and appearance, without requiring an internal sheath, which is an advantage in terms of weight-saving and effectiveness.

But it will be noted that the invention is not limited to the embodiment described.

Specifically, in the embodiment described above, the clamping member is made in the form of a metal sheet folded in the shape of a U-shaped section piece comprising two lateral branches that can be deformed by clamping by interaction with two ramps provided on the stop body.

Naturally, there is no departure from the context of the invention when the clamping member adopts any other configuration that can be deformed by clamping.

Finally, it will be noted that, as indicated above, the device according to the invention may also be made in the form of a sheath bushing designed for the running of a cable surrounded by its own sheath in a cycle frame.

FIG. 10 shows an overview of such a sheath bushing.

As can be seen in this figure, in which elements that are identical to those described above with reference to FIGS. 1 to 9 bear the same reference numbers, the sheath bushing comprises a body 6 having a structure similar to that of the stop body and a clamping member identical to the clamping member of the sheath stop.

Because of the envisaged application, the body 6 of the sheath bushing, which is moreover identical to the stop body, nevertheless has no bearing surface for the sheath and comprises an orifice 19 of enlarged diameter in order to allow the sheath to slide.

What is claimed is:

1. A removable device for running a cable in a cycle frame, comprising a body mounted resting on the frame in an opening made for running the cable and comprising an orifice for running the cable, characterized in that it comprises a clamping member mounted by screwing onto the body, the said clamping member being able to be deformed during screwing between a first, undeformed, rest configuration corresponding to a position in which the clamping member is inserted into the opening of the frame and a second, deformed configuration corresponding to a position in which the device is clamped against the frame.

2. The device according to claim 1, characterized in that the body comprises at least one additional orifice for the running of at least one other cable.

3. The device according to claim 1, characterized in that the clamping member has a shape to match that of the body and is prevented from rotating relative to the body in the undeformed position.

4. The device according to claim 1, characterized in that the clamping member has a U-shaped cross section and comprises a base provided with a thread designed to receive a clamping screw and two lateral branches each provided with an end rim designed to press against the frame.

5. The device according to claim 4, characterized in that the clamping member comprises a metal sheet folded in the form of a section piece.

6. The device according to claim 5, characterized in that the metal sheet is made of elastically deformable steel.

7. The device according to claim 4, characterized in that the body comprises a proximal head delimiting a peripheral shoulder designed to rest against an outer surface of the frame and a distal portion designed to be engaged in the opening of the frame.

8. The device according to claim 7, characterized in that the distal portion of the body comprises two divergent longitudinal ramps on which the lateral branches respectively of the clamping member are pressed.

9. The device according to claim 7, characterized in that the orifice of the body is inclined relative to the general plane of the proximal head.

10. The device according to claim 7, characterized in that the body also comprises an axial hole for the passage of a clamping screw.

11. The device according to claim 1, characterized in that the body is made of a rigid material, such as aluminium, a plastic material, a composite, or a plastic material with added fibres.

12. The device according claim 1, characterized in that it forms a cable-sheath stop, and in that the body comprises a bearing surface for the sheath, the said bearing surface for the sheath comprising an annular surface surrounding the said orifice.

13. The device according claim 1, characterized in that it forms a sheath bushing.

14. The device according to claim 2, characterized in that the clamping member has a shape to match that of the body and is prevented from rotating relative to the body in the undeformed position.

15. The device according to claim 2, characterized in that the clamping member has a U-shaped cross section and comprises a base provided with a thread designed to receive a clamping screw and two lateral branches each provided with an end rim designed to press against the frame.

16. The device according to claim 3, characterized in that the clamping member has a U-shaped cross section and comprises a base provided with a thread designed to receive a clamping screw and two lateral branches each provided with an end rim designed to press against the frame.

17. The device according to claim 5, characterized in that the body comprises a proximal head delimiting a peripheral shoulder designed to rest against an outer surface of the frame and a distal portion designed to be engaged in the opening of the frame.

18. The device according to claim 6, characterized in that the body comprises a proximal head delimiting a peripheral shoulder designed to rest against an outer surface of the frame and a distal portion designed to be engaged in the opening of the frame.

19. The device according to claim 8, characterized in that the orifice of the body is inclined relative to the general plane of the proximal head.

20. The device according to claim 8, characterized in that the body also comprises an axial hole for the passage of a clamping screw.
